(19) United States
(12) Patent Application Publication
(10) Pub. No.: US 2008/0296964 A1
(43) Pub. Date: Dec. 4, 2008

(54) LOCKING HUB ASSEMBLY

(76) Inventor: Tim Lee Williams, Mt. Ulla, NC (US)

Correspondence Address: MOORE & VAN ALLEN PLLC, P.O. BOX 13706, Research Triangle Park, NC, 27709, US

(21) Appl. No.: 12/059,704

(22) Filed: Mar. 31, 2008

Related U.S. Application Data
(60) Provisional application No. 60/909,243, filed on Mar. 30, 2007.

(51) Int. Cl. B60B 27/02

(52) U.S. Cl. 301/105.1

(57) ABSTRACT

The present invention is directed to a hub lock assembly for rotatably fixing a hub to a selectively powered rotating member. The hub lock assembly comprises a hub including a barrel having a bore therethrough defining internal splines. The hub lock assembly also comprises a spindle having a distal end defining external splines disposed within the barrel of the hub for rotatably supporting the hub. The spindle is adapted to be connected for rotation with the powered rotating member. The hub lock further comprises an actuator for switching the hub lock assembly between an engaged position where hub is rotatably fixed to the spindle and a disengaged position where the hub is free to rotate relative to the spindle. The actuator comprises a body member defining external splines and having a bore therethrough defining internal splines. The body member is disposed within the hub such that the external splines of the body member engage the internal splines of the hub for fixed rotation of the body member with the hub. The actuator also comprises a drive gear defining external splines and having a passage therethrough defining internal splines, the drive gear slidably disposed within the body member such that the external splines of the drive gear engage the internal splines of the body member for fixed rotation of the drive gear with the body member. The drive gear is movable within the body member relative to the hub and the spindle for moving the internal splines of the drive gear into an out of engagement with the splines on the distal end of the spindle. The actuator further comprises a cap that is adapted to be grasped and manipulated by a user. The cap is operatively connected to the body member for movement between an extended position for sliding the drive gear between the engaged position where the drive gear receives the distal end of the spindle and the internal splines of the drive gear are engaged with the external splines of the spindle for fixed rotation of the drive gar with the spindle, and a retracted position in the disengaged position where the drive is spared from the distal end of the spindle.

### CROSS-REFERENCES

This application is related to U.S. provisional application No. 60/909,243, filed Mar. 30, 2007, entitled “Road Shoulder Machine”, naming Tim Williams as the inventor. The contents of the provisional application are incorporated here by reference in their entirety, and the benefit of the filing date of the provisional application is hereby claimed for all purposes that are legally served by such claim for the benefit of the filing date.

### BACKGROUND

The present invention relates to a hub assembly, and more particularly concerns a manually actuated locking hub assembly with reduced assembly length and ease of use capabilities.

Conventional wheel hub assemblies on a vehicle typically consist of a wheel (i.e., a tire mounted to a rim) bolted to a spindled hub, which may be operatively connected to the vehicle's drive train. Vehicles sometimes provide optional engagement, or disengagement, of wheels. The wheels to be selectively engaged or disengaged are necessarily provided with a driveline from the vehicle power train. To avoid unnecessary energy consumption and wearing of out-of-service driveline components or, for example, when the vehicle is to be towed, hub locks are provided for disconnecting powered rotating axles from the wheels of the vehicle. Hub lock devices can be manually actuated, wherein a user manually turns a dial located in a wheel hub to activate the hub lock to engage or disengage the wheel from the axle.

One disadvantage of locking hub assemblies is that the assembly adds to the overall width of the wheel base. Such excess width may be unacceptable or disadvantageous in view of the operational goals of the vehicle. The wheel hub assemblies of previous designs may further include complex designs requiring numerous parts that render the device expensive to produce or complex to assemble.

For the foregoing reasons, there is a need for a new locking hub assembly which is compact and easy to use for quickly and securely connecting a wheel hub to a powered output shaft.

### SUMMARY

According to the present invention, a hub lock assembly for rotatably fixing a hub to a selectively powered rotating member may comprise a hub including a barrel having a bore therethrough defining internal splines. The hub lock assembly also comprises a spindle having a distal end defining external splines disposed within the barrel of the hub for rotatably supporting the hub. The spindle is adapted to be connected for rotation with the powered rotating member. The hub lock further comprises an actuator for switching the hub lock assembly between an engaged position where hub is rotatably fixed to the spindle and a disengaged position where the hub is free to rotate relative to the spindle. The actuator comprises a body member defining external splines and having a bore therethrough defining internal splines. The body member is disposed within the hub such that the external splines of the body member engage the internal splines of the hub for fixed rotation of the body member with the hub. The actuator also comprises a drive gear defining external splines and having a passage therethrough defining internal splines, the drive gear slidably disposed within the body member such that the external splines of the drive gear engage the internal splines of the body member for fixed rotation of the drive gear with the body member. The drive gear is movable within the body member relative to the hub and the spindle for moving the internal splines of the drive gear into an out of engagement with the splines on the distal end of the spindle. The actuator further comprises a cap that is adapted to be grasped and manipulated by a user. The cap is operatively connected to the body member for movement between an extended position for sliding the drive gear between the engaged position where the drive gear receives the distal end of the spindle and the internal splines of the drive gear are engaged with the external splines of the spindle for fixed rotation of the drive gar with the spindle, and a retracted position in the disengaged position where the drive is spared from the distal end of the spindle.

These and other objects, features and advantages of the present invention will be apparent from the following description thereof and appended claims in which references are made to the accompanying drawings.

### BRIEF DESCRIPTION OF THE DRAWINGS

For a more complete understanding of the present invention, reference should now be had to the embodiment(s) shown in the accompanying drawing(s) and described below. In the drawings:

FIG. 1 is a close-up perspective view of a wheel and a tire on a hub according to an embodiment of the present invention.

FIG. 2 is on exploded perspective view of the wheel, tire and hub shown in FIG. 1 including a portion of a drive motor assembly.

FIG. 3 is a perspective view of a hub assembly according to an embodiment of the present invention.

FIG. 4 is a front elevational view of the hub assembly shown in FIG. 3.

FIG. 5 is on exploded perspective view of the hub assembly shown in FIG. 3.

FIG. 6 is an elevated cross-sectional view of the hub assembly shown in FIG. 3 taken along line 6-6 of FIG. 4.

FIG. 7 is an elevated side view of a spindle according to an embodiment of the present invention for use in the hub assembly shown in FIG. 3.

FIG. 8 is an elevated side view of a hub according to an embodiment of the present invention for use in the hub assembly shown in FIG. 3.

FIG. 9 is on exploded perspective view of a locking cap for use in the hub assembly shown in FIG. 3.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

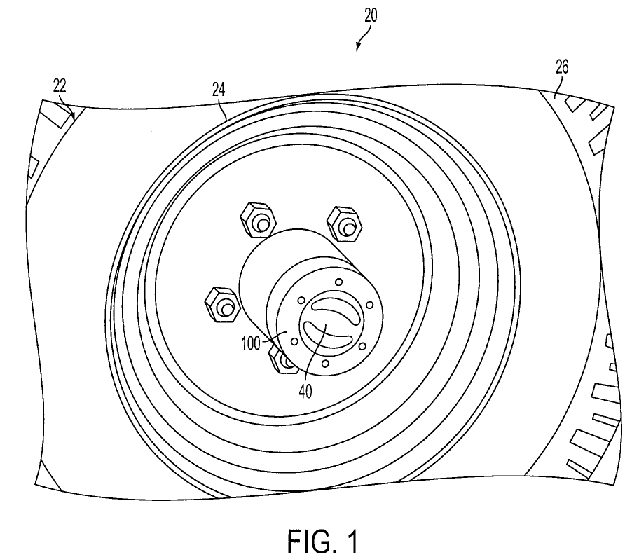

Referring now to the drawings, wherein like reference numerals designate corresponding or similar elements throughout the several views, a locking hub assembly according to an embodiment of the present invention is shown and generally designated at 20. With reference to FIG. 1, the locking hub assembly 20 is shown in place with a wheel 22, including a rim 24 and a tire 26. The wheel 22 is fixedly mounted to a hub 30 which is rotatably supported on a powered output shaft. As described in greater detail below, the locking hub assembly 20 couples or uncouples the wheel 22 and hub 30 to the output shaft by rotating a finger-controlled actuator knob 40.

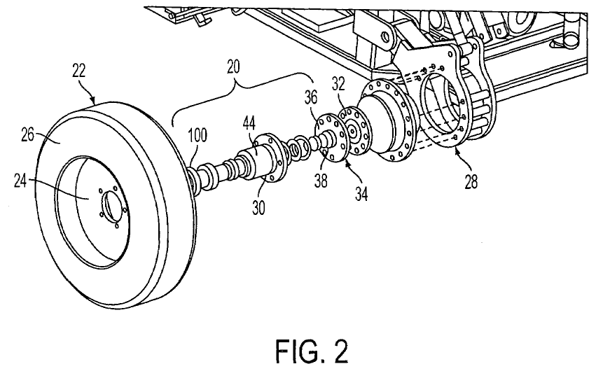

Referring now to FIG. 2, a selectively powered motor 28 is shown, including a rotor disc 32. The motor 28 drives the rotor disc 32 providing powered rotation of a spindle 34. The rotor disc 32 is fitted to a radial flange 36 at the proximal end of the spindle 34 so as to have a common axis of rotation. Corresponding circumferentially spaced bolt holes are provided in the rote disc 32 and the and the spindle 34 for connecting the rotor disc 32 to the spindle 34 using fasteners, such as bolts (not shown). The spindle 34 is rotatably supported in the hub 30. The hub 30 includes a radially extending flange portion 31 to which the wheel 22 is fastened by fasteners (not shown). In the drawings, the present invention is illustrated in conjunction with the wheel of a vehicle having a motor for providing powered output as a part of highway maintenance equipment, such as a road shoulder machine. It is understood that the locking hub assembly 20 of the present invention may be adapted for use with powered output shafts other than the one chosen for illustration herein.

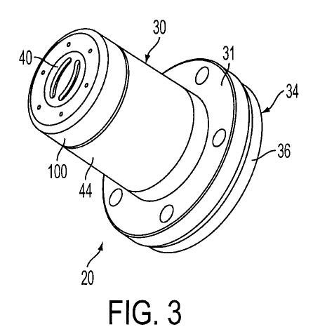

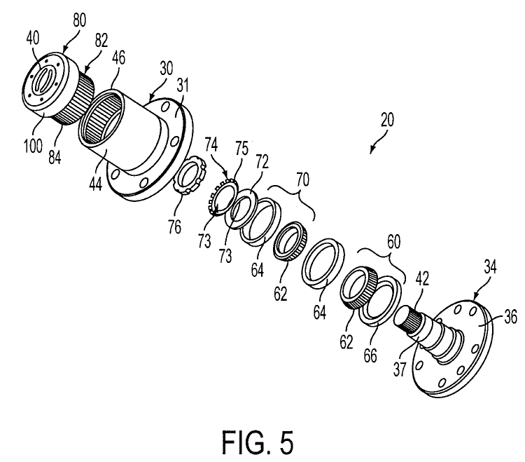

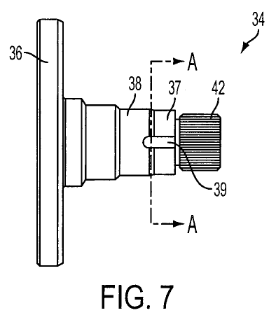

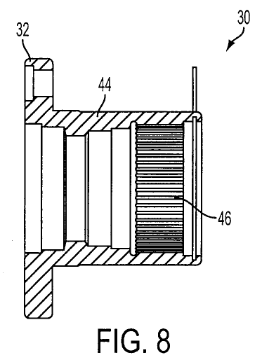

More detailed drawings of the locking hub assembly 20 are shown in FIGS. 3-6, comprising the spindle 34, the hub 30, an inner bearing assembly 60, an outer bearing assembly 70, and an actuating mechanism 80 for selectively engaging or disengaging the spindle 34 and the hub 30. The spindle 34 has a generally cylindrical distal end 38 extending from the radial flange 36. A portion of the distal end 38 of the spindle 34 is externally threaded 37 and defines a longitudinally extending slot 39 of generally rectangular cross-section. The extreme distal end 38 of the spindle 34 defines external splines 42.

The hub 18 includes a barrel 44 having a bore extending therethrough for receiving the distal end 38 of the spindle 34. The bore 44 includes an outer portion having internal splines 46.

As shown in FIG. 6, the distal end 38 of the spindle 34 extends into the hub 30. The spindle 34 provides rotatable support for the hub 30 and around which the hub selectively rotates. The inner surface of the barrel 44 of the hub 30 defines annular bearing shoulders formed at each end of the interior of the barrel 44 for receiving the inner and outer bearing assemblies 60, 70 for rotatively supporting the end 38 of the spindle 34. The inner bearing assembly 60 and the outer bearing assembly 70 are disposed between the hub 30 and the distal end of the spindle 34. Each of the bearing assemblies 60, 70 includes a roller bearing 62 which fits in a race portion 64.

The hub 30 is rotatably supported on the on the inner and outer bearing assemblies 60, 70 and retained by two axle washers 72, 74 and a retaining nut 76. The axle washers 72, 74 have generally annular bodies with circular central openings and tabs, or tangs, 73 which extend radially into the openings and are received in the longitudinal slot 39 extending along the threaded portion 37 of the spindle 34. The outer axle washer 74 has peripheral prongs 75 which extend at right angles to the body of the washer 74. The prongs 75 define a shallow cylinder of slightly greater depth than the nut 76. The hub 30, and thus the entire integral structure, is secured on the spindle 34 by the retaining nut 76 threadably installed on the end of the spindle 34. In the embodiment illustrated, the nut 76 is shown as a conventional hex nut with six flats or sides, but it can have any number of sides or noncircular shape desired. The nut 76 engages the washers 72, 74 and the race 64 of the inner bearing assembly 60 to clamp the inner bearing assembly 60 against the shoulder 48 of the barrel as shown in FIG. 6. Threading the nut 76, in turn, forces an inner shoulder of the hub 30 near the proximal end of the spindle 34 against the race 64 of the outer bearing assembly 70. The radial prongs 75 on the periphery of the outer axle washer 74 surround the nut 76. Spaces between the prongs 75 form notches which engage the corner portions of the nut 76 to hold the retaining nut 76 against rotation relative to the spindle 34. When assembled, this arrangement prevents unwanted rotation of the retaining nut 76 and other components of the hub assembly within the hub 30. An O-ring seal 66 is provided around the inner end of the cylindrical spindle portion 38 for providing a seal between the spindle 34 and the hub 30.

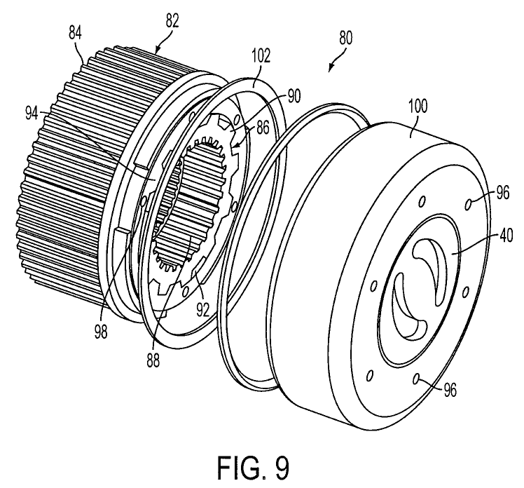

According to the present invention, a locking mechanism 80 is provided for releasably fixing the powered spindle 34 for rotation with the hub 30. The locking mechanism 80 is provided as a cartridge unit that is inserted in the outboard end of the barrel 44 of the hub 30. The locking mechanism 80, as best shown in FIG. 9, includes an externally splined sleeve 82, a drive gear 86 and the actuating knob 40. The sleeve 82 holds the locking system together as a unit. The sleeve 82 defines a bore therethrough for slidably receiving the drive gear 86. The splines 84 on the outer radial surface of the sleeve 82 are machined to slidingly engage the splines 46 on the inside surface of the hub 30. When assembled, the sleeve 82 is held in the barrel 44 of the hub 30 by a snap ring 102 and remains rotatably engaged with the hub 30 at all times.

The drive gear 86 is a cylindrical tubular element defining internal splines 88 adapted to axially receive the external splines 42 of the spindle 34 to provide fixed rotational movement of the drive gear 86 with the spindle 34. The inner drive gear 86 further includes a plurality of axially spaced exterior clutch teeth 90 which engage corresponding interior clutch teeth 92 defined by the inner surface of the sleeve 82. When assembled, the sleeve 82 remains engaged with the drive gear 86 at all times and both, therefore, rotate with the hub 30.

The knob 40 rotates within a peripheral cap 100. The cap is fixedly mounted to the outer end surface 94 of the sleeve 82 by threaded fasteners (not shown), which are received in holes 96 provided in the cap 100 and threaded bores 98 provided in the sleeve 82.

The locking mechanism 80 is mounted to the hub 30 for selectively coupling or uncoupling the hub 30 and the spindle 34. Movement of the drive gear 86 inwardly along the clutch teeth 92 of the sleeve 82 forces engagement of the splines 88 of the drive gear 86 with the splines 42 of the spindle 34. FIG. 6 shows the inner splines 88 of the drive gear 86 engaged with the spindle splines 42, in which mode torque may be transferred between the spindle 34 and the hub 30. Movement of the drive gear 86 in the opposite direction, outwardly, will uncouple the spindle 34 from the hub 30 since the splines 94 of the drive gear 86 will be out of engagement with the splines 42 of the spindle 34. The drive gear 86 disengaged from the spindle splines 42 allows independent rotation of the drive gear 86 and sleeve 82 relative to the spindle 34, thus freeing rotation of the hub 30 relative to the spindle 34.

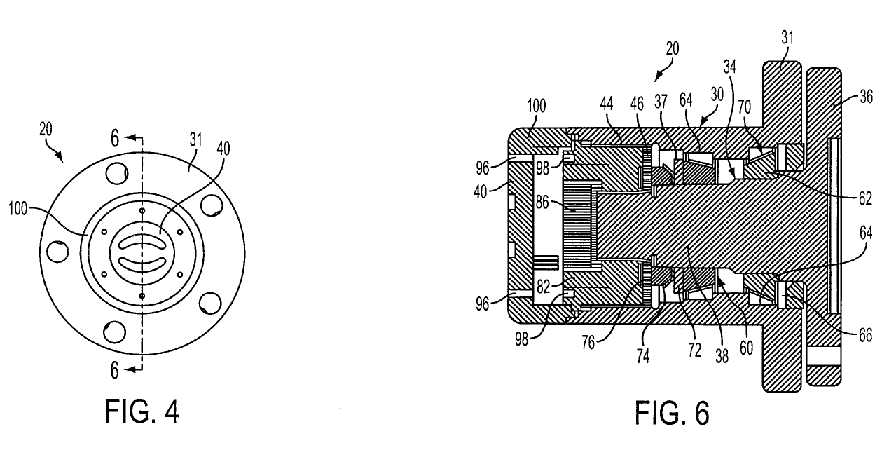

Inward and outward movement of the drive gear 86 is accomplished by turning the actuator knob 40. An inclined ramp is located on the inside surface (not shown) of the actuator knob 40. The ramp rides against the end surface of the drive gear 86 and converts rotation of the actuator knob 40 into longitudinal movement of the drive gear 86. Accordingly, rotation of the knob 40 relative to the sleeve 82 moves the drive gear 86 axially along the sleeve 82. Thus, the drive gear 86 can be displaced axially so that either the drive gear 86 engages the spindle 34 or the drive gear 86 is spaced from the spindle 34. In one embodiment, a clockwise motion (as viewed in FIG. 4) of the knob 40 forces the drive gear to move inwardly toward the spindle 34 and allows the drive gear 86 to slide over and engage the spindle splines 42. Conversely, a counterclockwise motion of the knob 40 frees the drive gear 86 to move outwardly in the sleeve 82. A spring (not shown) connects the drive gear to the cap 100 and, as a result, the drive gear 86 is pulled off and disengages the spindle 34.

In essence, therefore, the locking hub assembly 20 described above locks or unlocks rotation of the hub 30 on the spindle 34 when a user twists the actuator knob 40 so that the drive gear 86 is drawn outwardly or is pushed inwardly to achieve the above discussed engagement or disengagement of the drive gear 86 with the spindle 34.

A suitable locking mechanism as described herein is available from Warn Industries, Inc., of Milwaukie, Oreg., as part number YPW-62672.

The locking hub assembly of the present invention is easily assembled on a powered output shaft. In addition, the compact construction of the hub locking assembly allows it to substantially minimize the overall wheel base width of a vehicle.

Although the present invention has been shown and described in considerable detail with respect to only a particular exemplary embodiment thereof, it should be understood by those skilled in the art that I do not intend to limit the invention to the embodiment since various modifications, omissions and additions may be made to the disclosed embodiment without materially departing from the novel teachings and advantages of the invention, particularly in light of the foregoing teachings. For example, it should be understood that the locking hub assembly according to the present invention may be used with any powered rotating output shaft for selectively rotating a hub, whether or not it is a part of a vehicle. Accordingly, I intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. A hub lock assembly for rotatably fixing a hub to a selectively powered rotating member, the hub lock assembly comprising:
a hub including a barrel having a bore therethrough defining internal splines;
a spindle having a distal end defining external splines disposed within the barrel of the hub for rotatably supporting the hub, the spindle adapted to be connected for rotation with the powered rotating member; and
an actuator for switching the hub lock assembly between an engaged position where hub is rotatably fixed to the spindle and a disengaged position where the hub is free to rotate relative to the spindle, the actuator comprising:
a body member defining external splines and having a bore therethrough defining internal splines, the body member disposed within the hub such that the external splines of the body member engage the internal splines of the hub for fixed rotation of the body member with the hub;
a drive gear defining external splines and having a passage therethrough defining internal splines, the drive gear slidably disposed within the body member such that the external splines of the drive gear engage the internal splines of the body member for fixed rotation of the drive gear with the body member, the drive gear movable within the body member relative to the hub and the spindle for moving the internal splines of the drive gear into an out of engagement with the splines on the distal end of the spindle; and
a cap adapted to be grasped and manipulated by a user, the cap operatively connected to the body member for movement between an extended position for sliding the drive gear between the engaged position where the drive gear receives the distal end of the spindle and the internal splines of the drive gear are engaged with the external splines of the spindle for fixed rotation of the drive gar with the spindle, and a retracted position in the disengaged position where the drive is spared from the distal end of the spindle.
